(19) United States
(12) Patent Application Publication
(10) Pub. No.: US 2026/0212739 A1
(43) Pub. Date: Jul. 23, 2026

(54) LIGHTING SYSTEM FOR WALL MOUNTED CALL STATION

(71) Applicant: PEDESTAL PRO LLC, Lindon, UT (US)

(72) Inventors: Robert Pike Goss, III, Alpine, UT (US); Jess Deon Howell, American Fork, UT (US)

(21) Appl. No.: 19/064,605

(22) Filed: Feb. 26, 2025

Related U.S. Application Data
(63) Continuation-in-part of application No. 29/986,862, filed on Jan. 18, 2025.

(51) Int. Cl. F21V 23/04; F21V 15/01; F21V 33/00

(52) U.S. Cl. CPC G08B 5/38; F21V 23/0464; F21V 33/0052

(57) ABSTRACT

A call station including, a housing having a plurality of substantially vertically extending sides, where the plurality of substantially vertically extending sides includes a back side that is configured to be mounted to a wall. The housing also includes a top panel and a bottom panel, such that each of the plurality of substantially vertically extending sides are connected to both the top panel and the bottom panel. The call station also includes a plurality of substantially vertically extending openings in the housing, where the plurality of openings extend from a bottom portion of the housing to a top portion of the housing. The call station also has at least one light source mounted within the housing, where the at least one light source is configured to emit light through the plurality of openings in the housing, and a call box, configured to communicate with a remote communication device.

### CROSS-REFERENCE TO RELATED APPLICATIONS

This application is a continuation-in-part of U.S. Design Patent Application No. 29/986,862, filed Jan. 18, 2025, which is hereby incorporated by reference herein in its entirety, including but not limited to those portions that specifically appear hereinafter, the incorporation by reference being made with the following exception: In the event that any portion of the above-referenced application is inconsistent with this application, this application supercedes said above-referenced provisional application.

### STATEMENT REGARDING FEDERALLY SPONSORED RESEARCH OR DEVELOPMENT

Not Applicable.

### BACKGROUND

### 1. The Field of the Present Disclosure

The present disclosure is directed to wall mounted call stations, and more specifically to call stations having lighting systems designed to illuminate the call station and provide a user with a safe and convenient way to contact service providers from a remote location.

### 2. Description of Related Art

Conventionally, call stations have been used to provide user with a convenient way to contact service providers from remote areas where cell service may not be reliable or where a user may not be familiar with how to contact service providers, such as emergency services.

These call stations often rely on light emitted from nearby light poles or adjacent lighting systems. Sometimes these call stations may include a backlit user interface to provide illumination. Other times similar call stations may also include down-lighting so a user see the caller interface when attempting to contact a service or emergency provider.

Conventional call stations typically lack sufficient lighting capabilities which leave a call station less useful and less safe during nighttime or dark hours of a day or night and may lack any way to customize lighting protocol include different types of lighting for use as an emergency indicator.

Typical call stations may only include lighting on a front side of the call station, leaving significant portions of the call station dark and possibly difficult to see when approached from a side. Additionally, many of the uses of the call station are in nighttime emergencies, where a dimly lit call station may lack a sense of security and safety to a user, as opposed to a more well lit call station which may convey a safer environment.

The features and advantages of the present disclosure will be set forth in the description which follows, and in part will be apparent from the description, or may be learned by the practice of the present disclosure without undue experimentation. The features and advantages of the present disclosure may be realized and obtained by means of the instruments and combinations particularly pointed out in the appended claims. Any discussion of documents, acts, materials, devices, articles or the like which has been included in the present specification is not to be taken as an admission that any or all of these matters form part of the prior art base, or were common general knowledge in the field relevant to the present disclosure as it existed before the priority date of each claim of this application.

### BRIEF DESCRIPTION OF THE DRAWINGS

The features and advantages of the disclosure will become apparent from a consideration of the subsequent detailed description presented in connection with the accompanying drawings in which:

FIG. 1 is a front view of the disclosed device;

FIG. 2 is a side view of the disclosed device of FIG. 1;

FIG. 3 is a rear view of the disclosed device of FIG. 1;

FIG. 4 is a perspective view of the disclosed device of FIG. 1;

FIG. 5 is a bottom view of the disclosed device of FIG. 1;

FIG. 6 is a partially disassembled rear view, showing interior components of the disclosed device of FIG. 1; and

FIG. 7 is a wire diagram view of the electrical connection of internal components of the disclosed device of FIG. 1.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended.

Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

It must be noted that, as used in this specification and the appended claims, the singular forms “a,” “an,” and “the” include plural referents unless the context clearly dictates otherwise.

In describing and claiming the present disclosure, the following terminology will be used in accordance with the definitions set out below.

As used herein, the terms “comprising,” “including,” “containing,” “characterized by,” and grammatical equivalents thereof are inclusive or open-ended terms that do not exclude additional, unrecited elements or method steps.

As used herein, the phrase “wall mounted,” and grammatical equivalents thereof is broadly defined and used herein to include any first structure that is attached, connected, fixed, coupled or otherwise secured to an adjacent support structure or wall. The support structure or wall may extend vertically or substantially vertically, such that the first structure may be laterally attached, connected, fixed, coupled or otherwise secured to the adjacent support structure or wall.

As used herein, the term “controller,” and grammatical equivalents thereof is broadly defined and used herein to include any mechanical or electrical or electronic component capable of being programmed to control the operation of additional electrical or mechanical components.

As used herein, the term “call box,” and grammatical equivalents thereof is broadly defined and used herein to include any mechanism, communication device, or communication system capable of communicating with another remote communication device which may include a mechanism, communication device, or communication system. A “call box” may communicate through hard phone lines, cell tower services, satellite phone services, other wireless communication systems, or any other communication service or server.

As used herein, the phrase “a plurality of substantially vertically extending openings” and grammatical equivalents thereof is broadly defined and used herein to include multiple continuous or discontinuous openings that substantially or generally align in a substantially or generally vertical direction.

As used herein, the phrase “a plurality of openings extend from a bottom portion of the housing to a top portion of a housing” and grammatical equivalents thereof is broadly defined and used herein to include multiple continuous or discontinuous openings that are substantially or generally aligned and at least one of the multiple continuous or discontinuous openings is located at least partially within a bottom portion of the housing, and at least one of the multiple continuous or discontinuous openings is located at least partially within a top portion of the housing, and at least one of the multiple continuous or discontinuous openings is located at least partially within a center portion of the housing.

As used herein, the term “bottom portion,” and grammatical equivalents thereof is broadly defined and used herein to include a bottom terminating end of a structure and a section of the structure adjacent to the bottom terminating end of the structure. For example, as used herein, “bottom portion” may include a section of the housing which includes the bottom terminating end of the housing and extends adjacent to the bottom terminating end of the housing to also include a section of the housing that includes at least a portion of at least one substantially vertically extending opening. As other examples, the “bottom portion” may also include a section of the housing which includes the bottom terminating end of the housing and extends adjacent to the bottom terminating end at a length 0-35% of the height of the housing, or 0-10%, or 0-20%, or 2%, 5%, 8%, 10%, 15%, 20%, 30% of the height of the housing.

As used herein, the term “top portion,” and grammatical equivalents thereof is broadly defined and used herein to include a top terminating end of a structure and a section of the structure adjacent to the top terminating end of the structure. For example, as used herein, “top portion” may include a section of the housing which includes the top terminating end of the housing and extends adjacent to the top terminating end of the housing to also include a section of the housing that includes at least a portion of at least one substantially vertically extending opening. As other examples, the “top portion” may also include a section of the housing which includes the top terminating end of the housing and extends adjacent to the top terminating end at a length 0-35% of the height of the housing, or 0-10%, or 0-20%, or 2%, 5%, 8%, 10%, 15%, 20%, 30% of the height of the housing.

As used herein, the term “center portion,” and grammatical equivalents thereof is broadly defined and used herein to include any area or portion that is located, positioned, or exists between the top portion, as defined above, and the bottom portion, as defined above.

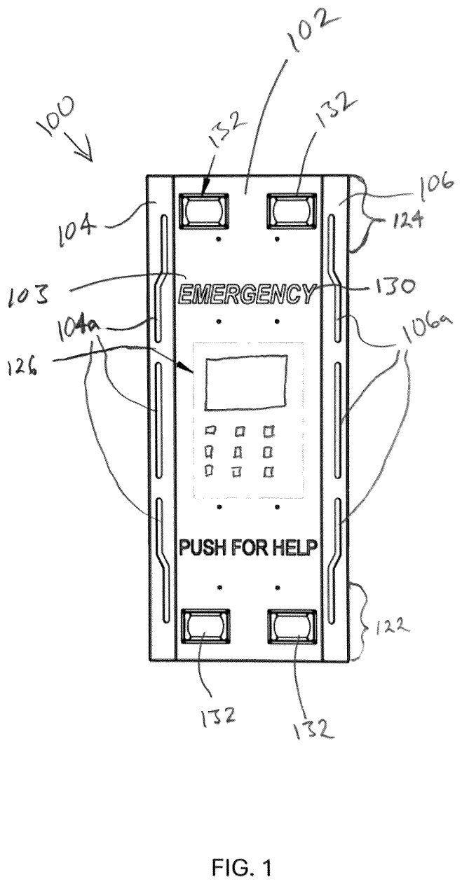

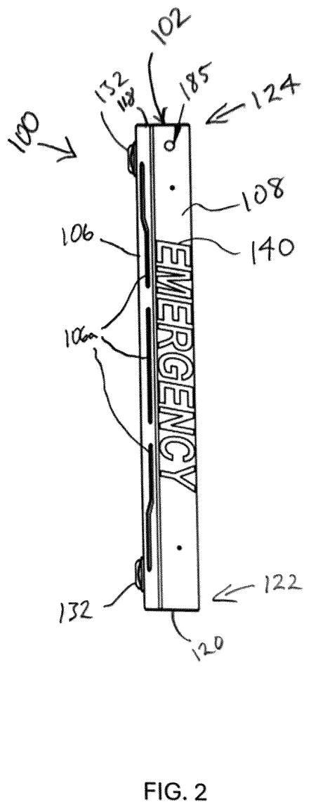

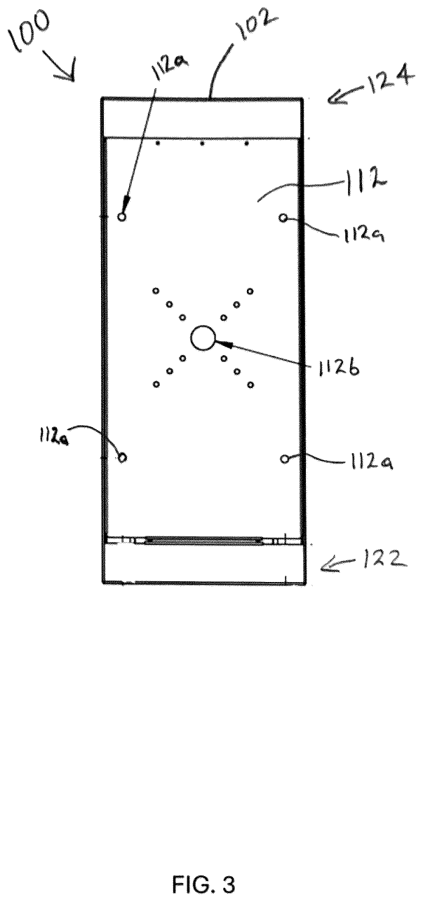

FIGS. 1-7 illustrate a wall mounted call station 100. The call station 100 may include a housing 102 that may include multiple substantially vertically extending sides, including a front side 103, a first angled front side 104, a second angled front side 106, a first side 108, a second side 110, and a rear side 112. These substantially vertically extending sides may have a vertical height that is substantially greater that their respective horizontal widths. These substantially vertically extending sides may also be substantially planar, however, in alternative embodiments any of the substantially vertically extending sides may include different shapes and contours that may not be substantially planar.

The housing 102 may include any desired number of substantially vertically extending sides, which may form any desired shape or cross-sectional shape. As shown in FIGS. 1-7, the disclosed housing 102 may include six substantially vertically extending sides, specifically, the front side 103, the first angled front side 104, the second angled front side 106, the first side 108, the second side 110, and a rear side 112. However, other embodiments not shown may be formed having more or less sides, forming difference cross-sectional shapes.

The first angled front side 104 and the second angled front side 106 may be formed at an angle greater than 90 degrees and less than 180 degrees with respect to the front side 103.

The housing 102 may also include a top panel 118, and a bottom panel 120. The top panel 118 and a bottom panel 120 may be designed an configured such that each of the plurality of substantially vertically extending sides may be connected to both the top panel 118 and the bottom pane 120. This connection may be welded, integrally formed, attached via adhesive or fasteners, or any other desired connection. The housing 102 may be substantially hollow, having an interior space designed and configured to house multiple components critical to the operation and functionality of the call station 100.

The first angled front side 104 and the second angled front side 106 may include a plurality of openings 104a and 106a. These openings 104a and 106a may be formed in a way that they extend in a substantially vertical direction from a bottom portion 122 of the housing 102 to a top portion 124 of the housing 102. Each opening 104a and 106a may extend a greater distance in the vertical direction with respect to the call station 100, than in the horizontal direction with respect to the call station 100.

The openings 104a and 106a may extend within three inches of the bottom terminating end of the angled front sides 104 and 106, and extend to within three inches of the top terminating end of the angled front sides 104 and 106. The openings 104a and 106a may extend completely through the respective angled front sides 104 and 106 allowing light from a light source within the housing 102 to emanate through the openings 104a and 106a. Due to the respective positioning and respective angles of the angled front sides 104 and 106, the light emitted through the openings 104a and 106a may extend more than 180 degrees around the exterior of the call station 100. There may be a plurality of openings, including three distinct openings on each respective side, or any other desired number of openings.

Additionally, since the openings 104a and 106a extend along a significant majority of the vertical height the housing 102, the entire housing 102 of the call station 100 is well lit can provide a safe and convenient user experience and can be seen from great distance away from the call station 100, enabling a user to locate the call station 100, when in need, such as in an emergency situation.

The front side 103 may also include a call box 126 attached thereto. The call box 126 may be attached such that a user may use the call box 126 to contact a service provider, such as an emergency service provider, maintenance provider, or other custom service providers or any other custom parties capable of receiving a phone call. The call box 126 may include an interface that may enable a user to make a call. The call box 126 may be designed and configured to be connected to a land-line phone cable, or may be configured to make calls using cell phone towers and related phone services or satellite phone services, or other similar phone services that may allow a user to make a call from the call station 100 to a remote location.

The front side 103 may also include labeling or text 130 that may inform a user of the uses of the call tower 100. For example, in FIG. 1 the text reads “EMERGENCY” which is designed to indicate to a user that the call station 100 may be used in case of an emergency situation. Alternatively, the text 130 may be customizable to any desired text, logo, advertizement or any other desired words or design. The text may be illuminated, adding additional overall illumination to the call station 100, as well as emphasizing the text 130.

The front side 103 may also include multiple or a plurality of strobe lights 132. The front side 103 may have four strobe lights 132, a single strobe light 132 or any desired number of strobe lights 132. The strobe lights 132 may be positioned at the bottom portion 122 and the top portion 124 of the housing 102 on the front side 103. The strobe lights 132 may be programmable to turn on when initiated by a user of the call station 100, or may be turned on at predetermined time periods or time intervals. The strobe lights 132 may also be customizable to vary the rate of the flashing light, light intensity such as dimming, and/or color of the light being emitted.

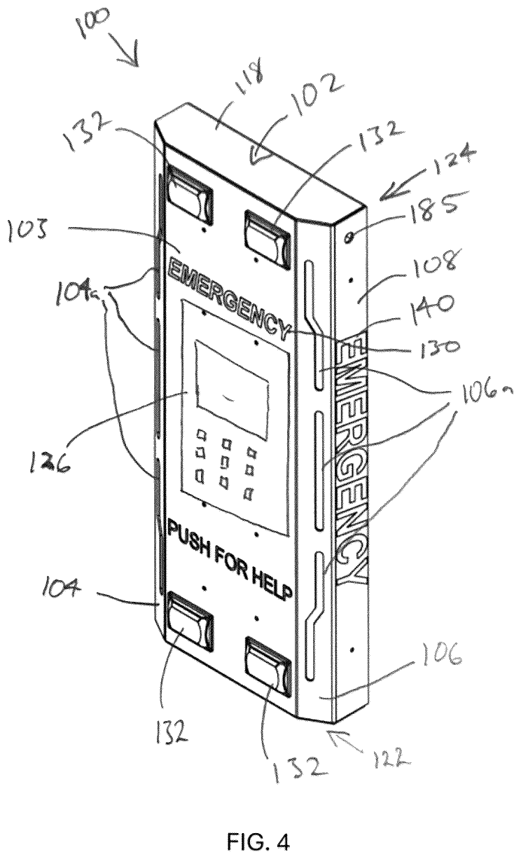

The first side 108 and the second side 110, may be substantially identical in construction and design. Although, if desired the first side 108 may include different features or attributes than the second side 110. The first side and the second side may include labeling or text 140 that may inform a user of the uses of the call station 100. For example, in FIG. 4 the text reads “EMERGENCY” which is designed to indicate to a user that the call station 100 may be used in case of an emergency situation. Alternatively, the text 140 may be customizable to any desired text, logo, advertizement or any other desired words or design. The text may be illuminated, adding additional overall illumination to the call station 100, as well as emphasizing the text 140.

The rear side 112 may be formed or constructed such that the rear side may be substantially parallel with the front side 103. The rear side 112 may designed and configured to be mounted to a wall or other adjacent surface (not shown). Rear side 112 may be attached, connected, fixed, coupled or otherwise secured to an adjacent support structure or wall. The support structure or wall may extend vertically or substantially vertically, such that the rear side 112 may be laterally attached, connected, fixed, coupled or otherwise secured to the adjacent support structure or wall.

The rear side 112 may be secured to an adjacent support structure or wall using fasteners, such as bolts, screws, rivets, or other desired fasteners., The rear side 112 may include a plurality of pre-drilled opening or holes 112a configured to received respective fasteners (not shown) which can be used to secure the call station 100 to adjacent support structure or wall.

The rear side 112 may include a utility opening 112b or “knock out” area, configured to received utility lines, which may include communication lines, power lines, data lines, or any other desired line to be run from an external location from the call station 100 and into connection with internal components of the call station 100, such as a controller, a power supply, and/or the call box 126. The utility opening may also be designed and configured to receive additional fasteners and/or support structures.

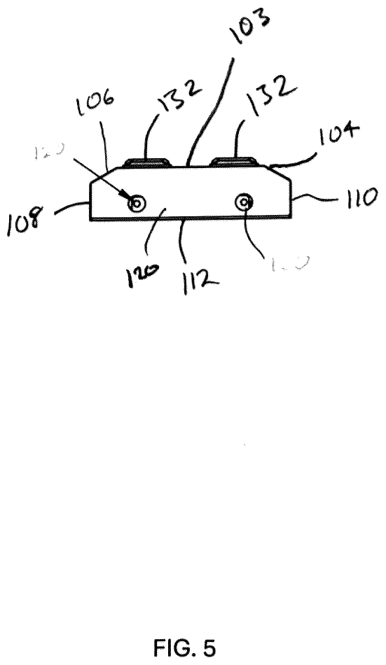

FIG. 5 shows the bottom panel 120 of the call station 100. The bottom panel 120 may be substantially planar but may include an openings 120a. The openings 120a may be designed and configured to receive fasteners capable of removably securing the bottom panel 120 to the body 102 of the call station 100. Being able to remove the bottom panel 120, may allow a user or technician to access internal components of the call station 100 without removing the call station 100 from the wall it may be secured to.

FIG. 4 shows the top panel 118 of the call tower 100. The top panel may be substantially planar and may be formed as a unitary piece of the housing 102 or may be removably secured to the housing 102 to provide closure of the interior space of the housing 102 and protect the interior space from the elements of the surrounding environment.

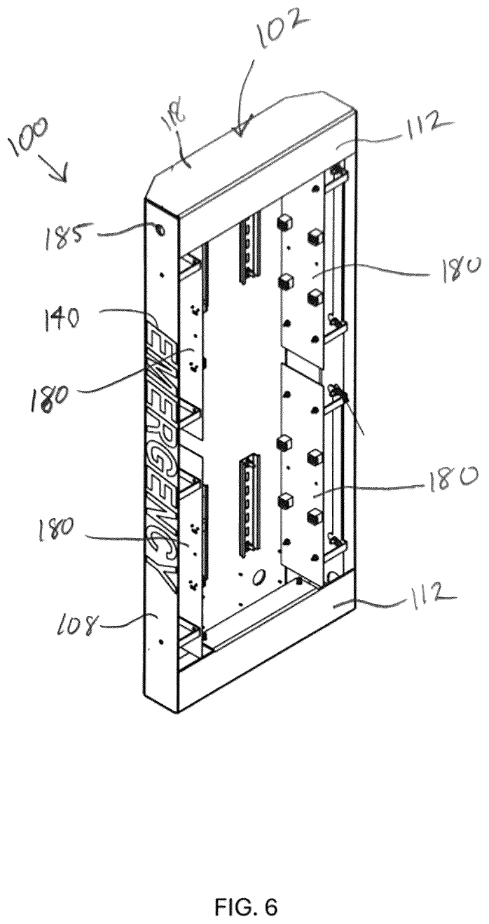

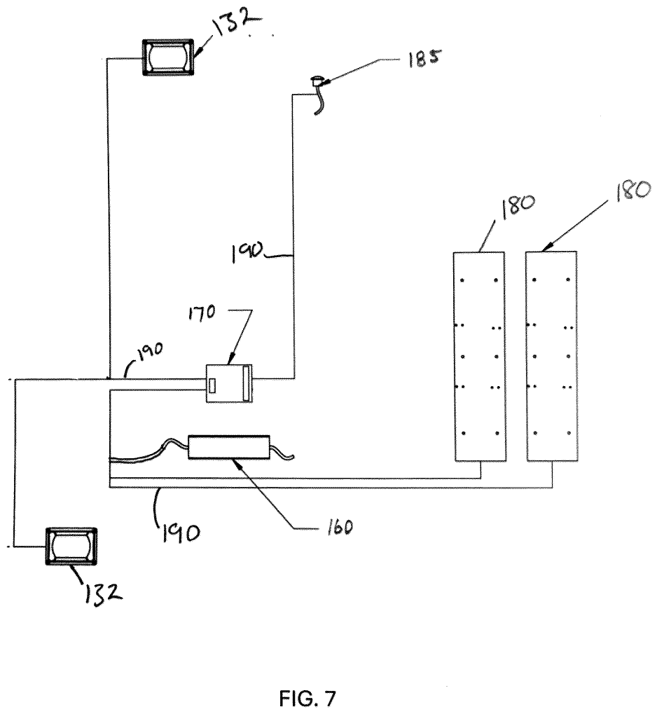

FIGS. 6 and 7 illustrate the interior components of the call tower 100. A power supply 160 may be electrically connected to an outside power source, such as a power line (not shown) or the power supply 160 may provide power to the call tower 100 via a batter or batter cells (not shown).

The power supply 160 may be electrically connected to and provide power to a controller 170, light boards 180 and a photocell sensor 185. These electrical connections may be provided by hard wiring 190, or any other mechanism capable of providing power and/or information between the power supply 160, controller 170, light boards 180, photocell sensor 185, and/or strobe lights 132. The power supply 160 may be mounted on any desired interior surface of the housing 102.

The light boards 180, may act as a light sources for all of the openings 104a, 106a, as well as, providing a light source for the illuminated text 130, 140 and 150. The light boards 180 may include a plurality of LED lights, or any other desired light sources capable for producing varying colors of visible light. The light boards 180 may be mounted on any desired interior surface of the housing 102.

The photocell sensor 185 may be used to detect the ambient light around the call tower 100. The photocell sensor 185 can also determine if it is nighttime and dark or daytime and light. The photocell sensor 185 may also determine is it is unusually dark or light, such as on overcast days, or if the call tower is positioned in an enclosed space with artificial light. The photocell sensor 185 can then send the light condition data to the controller. The photo cell sensor can also be mounted to the side 108, however, the photocell sensor may be mounted to any desired side or surface on the housing 102.

The controller 170 may be designed and configured to control when the light boards 180 are turned on, the duration of time the light boards 180 are illuminated, light intensity such as dimming, the color of the light being emanated. The controller can also be programmed to determine a preset time when the light boards turn on and when they turn off. The controller 170 can also be programmed to activate, deactivate, turn on or off the light boards 180 based on ambient light information detected and provided by the photocell 185.

The controller 170 may be designed and configured to control when the strobe lights 132 are turned on, the duration of time the strobe lights 132 are illuminated, strobe light intensity such as dimming, the color of the light being emanated. The controller can also be programmed to determine a preset time when the light boards turn on and when they turn off.

The controller 170 can also be programmed to activate, deactivate, turn or off the light boards 180 based on ambient light information detected and provided by the photocell 185. The controller may also be programmed to include an alarm mode which may active the strobe lights 132 and light boards 180 at predetermined rates, time period, light intensity such as dimming, and/or light colors. The controller 170 may be mounted on any desired interior surface of the housing 102.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as future included claims may reflect, inventive aspects lie in less than all features of a single foregoing disclosed embodiment.

It is to be understood that the above-described arrangements are only illustrative of the application of the principles of the present disclosure. Numerous modifications and alternative arrangements may be devised by those skilled in the art without departing from the spirit and scope of the present disclosure.

Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed:

1. A call station comprising:
a housing having a plurality of substantially vertically extending sides,
wherein the plurality of substantially vertically extending sides includes a back side that is configured to be mounted to a wall;
wherein the housing also includes a top panel and a bottom panel, such that each of the plurality of substantially vertically extending sides are connected to both the top panel and the bottom panel;
a plurality of substantially vertically extending openings in the housing, wherein the plurality of openings extend from a bottom portion of the housing to a top portion of the housing;
at least one light source mounted within the housing, wherein the at least one light source is configured to emit light through at least a portion of the plurality of openings in the housing; and
a call box, configured to communicate with a remote communication device.

2. The call station of claim 1, wherein the plurality of substantially vertically extending sides includes a front side that is substantially parallel to the back side.

3. The call station of claim 1, wherein the remote communication device is an emergency service provider.

4. The call station of claim 1, further comprising:
at least one strobe light mounted on at least one of the plurality of substantially vertically extending sides.

5. The call station of claim 1, wherein the back side includes a plurality of openings configured to received fasteners for mounting the call station to a wall.

6. The call station of claim 2, wherein multiple of the plurality of substantially vertically extending sides include text that is illuminated by the light source.

7. The call station of claim 1, wherein the plurality of substantially vertically extending openings are formed in multiple of the plurality of substantially vertically extending sides.

8. The call station of claim 1, wherein the plurality of substantially vertically extending openings are formed in two of the plurality of substantially vertically extending sides.

9. The call station of claim 1, further comprising:
a controller that is configured to adjust the light emitted from the light source, including changing at least one of: a color of the light, dimming of the light, a duration the light is on, a timing of when the light turns on.

10. The call station of claim 1, further comprising:
a controller that is configured to adjust the light emitted from the strobe light, including changing at least one of: a color of the light, a duration the light is on, dimming of the light, a timing of when the light turns on.

11. The call station of claim 1, further comprising:
a photocell sensor to determine ambient light around the call tower.

12. The call station of claim 9, further comprising:
a photocell sensor to determine ambient light around the call tower, wherein the controller adjusts the light emitted from the light source based on the ambient light detected by the photocell.

13. A call station comprising:
a housing having a plurality of substantially vertically extending sides,
wherein the plurality of substantially vertically extending sides includes a back side that is configured to be mounted to a wall;
wherein the housing also includes a top panel and a bottom panel, such that each of the plurality of substantially vertically extending sides are connected to both the top panel and the bottom panel;
a plurality of substantially vertically extending openings in the housing, wherein the plurality of openings extend from a bottom portion of the housing to a top portion of the housing;
at least one light source mounted within the housing, wherein the at least one light source is configured to emit light through the plurality of openings in the housing; and
a controller that is configured to adjust the light emitted from the light source, including changing at least one of: a color of the light, a duration the light is on, a timing of when the light turns on.

14. The call station of claim 13, wherein the plurality of substantially vertically extending sides includes a front side that is substantially parallel to the back side.

15. The call tower of claim 13, wherein the remote communication device is an emergency service provider.

16. The call station of claim 13, further comprising:
at least one strobe light mounted on at least one of the plurality of substantially vertically extending sides.

17. The call station of claim 13, wherein the back side includes a plurality of openings configured to received fasteners for mounting the call station to a wall.

18. The call station of claim 13, wherein multiple of the plurality of substantially vertically extending sides include text that is illuminated by the light source.

19. The call station of claim 13, wherein the plurality of substantially vertically extending openings are formed in multiple of the plurality of substantially vertically extending sides.

20. The call station of claim 13, wherein the plurality of substantially vertically extending openings are formed in two of the plurality of substantially vertically extending sides.

21. The call station of claim 13, further comprising:
a controller that is configured to adjust the light emitted from the light source, including changing at least one of: a color of the light, dimming of the light, a duration the light is on, a timing of when the light turns on.

22. The call station of claim 13, further comprising:
a controller that is configured to adjust the light emitted from the strobe light, including changing at least one of: a color of the light, a duration the light is on, dimming of the light, a timing of when the light turns on.

23. The call station of claim 13, further comprising:
a photocell sensor to determine ambient light around the call tower.

24. The call station of claim 22, further comprising:
a photocell sensor to determine ambient light around the call tower, wherein the controller adjusts the light emitted from the light source based on the ambient light detected by the photocell.

25. A call tower comprising:
a housing having a plurality of substantially vertically extending sides,
wherein the plurality of substantially vertically extending sides includes a back side that is configured to be mounted to a wall;
a plurality of substantially vertically extending openings in the housing, wherein the plurality of openings extend from a bottom portion of the housing to a top portion of the housing;
at least one light source mounted within the housing, wherein the at least one light source is configured to emit light through the plurality of openings in the housing;
a call box, configured to communicate with a remote communication device, and
a controller that is configured to adjust the light emitted from the light source, including changing at least one of: a color of the light, a duration the light is on, a timing of when the light turns on.

26. The call tower of claim 25, wherein the remote communication device is an emergency service provider.

27. The call station of claim 25, wherein the plurality of substantially vertically extending sides includes a front side that is substantially parallel to the back side.

28. The call station of claim 25, wherein the remote communication device is an emergency service provider.

29. The call station of claim 25, further comprising:
at least one strobe light mounted on at least one of the plurality of substantially vertically extending sides.

30. The call station of claim 25, wherein the back side includes a plurality of openings configured to received fasteners for mounting the call station to a wall.

31. The call station of claim 25, wherein multiple of the plurality of substantially vertically extending sides include text that is illuminated by the light source.

32. The call station of claim 25, wherein the plurality of substantially vertically extending openings are formed in multiple of the plurality of substantially vertically extending sides.

33. The call station of claim 25, wherein the plurality of substantially vertically extending openings are formed in two of the plurality of substantially vertically extending sides.

34. The call station of claim 25, wherein the controller that is configured to adjust the light emitted from the strobe light, including changing at least one of: a color of the light, dimming of the light, a duration the light is on, a timing of when the light turns on.

35. The call station of claim 25, further comprising:
a photocell sensor to determine ambient light around the call tower, wherein the controller adjusts the light emitted from the light source based on the ambient light detected by the photocell.

36. A method of using a call tower comprising:
providing a housing having a plurality of substantially vertically extending sides,
wherein the plurality of substantially vertically extending sides includes a back side that is configured to be mounted to a wall;
wherein the housing also includes a top panel and a bottom panel, such that each of the plurality of substantially vertically extending sides are connected to both the top panel and the bottom panel;
providing a plurality of substantially vertically extending openings in the housing, wherein the plurality of openings extend from a bottom portion of the housing to a top portion of the housing;
providing at least one light source mounted within the housing, wherein the at least one light source is configured to emit light through the plurality of openings in the housing;
providing a call box, configured to communicate with a remote communication device;
emitting light through the plurality of substantially vertically extending openings; and
calling a remote communication device using the call box.

37. The method of claim 36, wherein the plurality of substantially vertically extending sides includes a front side that is substantially parallel to the back side.

38. The method of claim 36, wherein the remote communication device is an emergency service provider.

39. The method of claim 36, further comprising:
providing at least one strobe light mounted on at least one of the plurality of substantially vertically extending sides.

40. The method of claim 36, wherein the back side includes a plurality of openings configured to received fasteners for mounting the call station to a wall.

41. The method of claim 36, wherein multiple of the plurality of substantially vertically extending sides include text that is illuminated by the light source.

42. The method of claim 36, wherein the plurality of substantially vertically extending openings are formed in multiple of the plurality of substantially vertically extending sides.

43. The method of claim 36, wherein the plurality of substantially vertically extending openings are formed in two of the plurality of substantially vertically extending sides.

44. The method of claim 36, further comprising:
providing a controller that is configured to adjust the light emitted from the light source, including changing at least one of: a color of the light, dimming of the light, a duration the light is on, a timing of when the light turns on.

45. The method of claim 36, further comprising:
providing a controller that is configured to adjust the light emitted from the strobe light, including changing at least one of: a color of the light, dimming of the light, a duration the light is on, a timing of when the light turns on.

46. The method of claim 36, further comprising:
providing a photocell sensor to determine ambient light around the call tower.

47. The method of claim 44, further comprising:
providing a photocell sensor to determine ambient light around the call tower, wherein the controller adjusts the light emitted from the light source based on the ambient light detected by the photocell.

48. A call station comprising:
a housing having a plurality of substantially vertically extending sides,
wherein the plurality of substantially vertically extending sides includes a back side that is configured to be mounted to a wall;
wherein the housing also includes a top panel and a bottom panel, such that each of the plurality of substantially vertically extending sides are connected to both the top panel and the bottom panel;
wherein the plurality of substantially vertically extending sides includes a front side that is substantially parallel to the back side;
a plurality of substantially vertically extending openings in the housing, wherein the plurality of openings extend from a bottom portion of the housing to a top portion of the housing;
wherein multiple of the plurality of substantially vertically extending sides include text that is illuminated by the light source;
at least one light source mounted within the housing, wherein the at least one light source is configured to emit light through the plurality of openings in the housing; and
a call box, configured to communicate with a remote communication device, wherein the remote communication device is an emergency service provider;
a photocell sensor to determine ambient light around the call tower;
a controller that is configured to adjust the light emitted from the light source, including changing at least one of: a color of the light, dimming of the light, a duration the light is on, a timing of when the light turns on; and
a plurality of strobe lights mounted on a plurality of the substantially vertically extending sides;
wherein the plurality of substantially vertically extending openings are formed in two of the plurality of substantially vertically extending sides, and
wherein the controller is configured to adjust the light emitted from the strobe light, including changing at least one of: a color of the light, a duration the light is on, a timing of when the light turns on.
